(19) United States
(12) Patent Application Publication
(10) Pub. No.: US 2014/0126876 A1
(43) Pub. Date: May 8, 2014

(54) CAP FOR OPTICAL FIBER

(71) Applicant: OFS Fitel, LLC, Norcross, GA (US)

(72) Inventors: Jie Li, Unionville, CT (US); Xiaoguang Sun, West Hartford, CT (US)

(21) Appl. No.: 14/070,710

(22) Filed: Nov. 4, 2013

Related U.S. Application Data
(60) Provisional application No. 61/722,500, filed on Nov. 5, 2012.

(51) Int. Cl. G02B 6/02; C03B 37/01

(52) U.S. Cl. CPC G02B 6/02395; C03B 37/01
USPC 385/139; 65/417; 65/397

(57) ABSTRACT

An optical fiber with a shaped tip is covered by a cap that is fused to the optical fiber using doped silica. The doped silica has a melting temperature that is lower than the melting temperature of the optical fiber. The doped silica also has a melting temperature that is lower than the melting temperature of the cap.

### CROSS REFERENCE TO RELATED APPLICATIONS

This application claims the benefit of U.S. provisional patent application serial number 61/722,500, filed 2012 Nov. 5, having the title “Silica Tube with Inner Softer Layer,” which is incorporated herein by reference in its entirety.

### BACKGROUND

1. Field of the Disclosure

The present disclosure relates generally to optical fibers and, more particularly, to caps for optical fibers.

2. Description of Related Art

Often, end-caps are placed on side-firing optical fibers. Typically, the end-caps (or cap) are secured to the optical fibers (or fibers) using epoxy. However, use of the epoxy often results in a gap between the fiber and the cap. The gap results in a corresponding reflection loss, which potentially increases the temperature of the fiber tip. Consequently, there are continued efforts related to side-firing optical fibers.

### SUMMARY

The present disclosure provides for an optical fiber with a shaped tip, which is covered by a silica cap that is fused to the optical fiber with a layer of doped silica. The doped silica has a melting temperature that is lower than the melting temperature of the optical fiber. The doped silica may also have a melting temperature that is lower than the melting temperature of the silica cap.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing a cut-away side view of one embodiment of a side-firing optical fiber with a silica cap.

### DETAILED DESCRIPTION OF THE EMBODIMENTS

Optical fibers having shaped tips, such as side-firing optical fibers with angled tips, are now being used in applications, such as laser ablation surgery. Often, a cap is secured to the tip of an optical fiber to protect the tip from damage or prevent accumulation of unwanted residue on the tip. In the past, caps have been secured to the optical fibers using epoxy. However, epoxy can result in a gap between the fiber and the cap, thereby resulting in a reflection loss of approximately eight (8) percent. This reflection loss can increase the temperature at the fiber tip causing undesired effects. Due to performance issues related to epoxy, others have proposed fusing a silica cap to the optical fiber. However, high temperatures associated with fusing the silica cap can also result in undesired deformation of the tip.

The present disclosure seeks to overcome these issues by providing a thin layer of doped glass that has a lower melting temperature than that of either the optical fiber or the cap. Interposing a lower-melting-temperature doped glass between the optical fiber and the cap allows the cap to be fused to the optical fiber at a lower temperature, thereby reducing the likelihood of unwanted heat-related deformations.

With this in mind, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

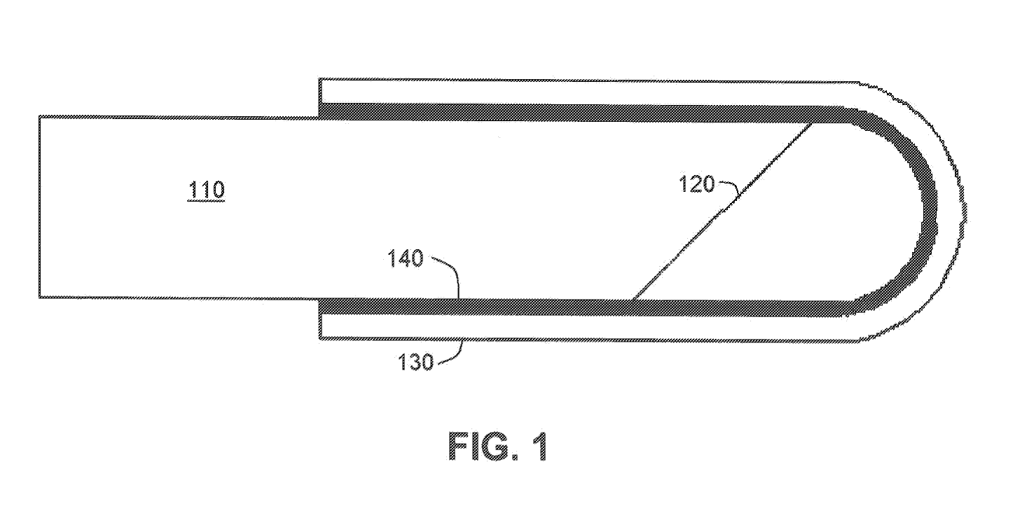

FIG. 1 is a diagram showing a cut-away side view of one embodiment of an optical fiber with a silica cap. As shown in FIG. 1, the fiber-optic apparatus comprises an optical fiber 110 and a cap 130. The optical fiber 110 comprises a shaped tip 120. Specifically, for the embodiment of FIG. 1, the shaped tip 120 is an angled tip, thereby making the fiber 110 a side-firing optical fiber. For some embodiments, the cap 120 is a silica cap that is formed from a capillary tube with a thin layer of doped silica 130 that is deposited on the inner surface of the capillary tube.

As shown in FIG. 1, the cap 130 covers the shaped tip 120 and is secured to the optical fiber 110 by fusing the cap 120 to the optical fiber 110 using the doped silica layer 140. The doped silica layer 140 has a melting temperature that is lower than the melting temperature of the optical fiber 110, and also lower than the melting temperature of the cap 120. This can be accomplished by doping the doped silica layer 140 with Germanium (Ge), Boron (B), Fluorine (F), or any other dopant or co-dopant that is known to reduce the melting temperature of silica. Since silica has a melting temperature that exceeds approximately 1,500 degrees Celsius, both the optical fiber 110 and the silica cap 130 each have a melting temperature that exceeds approximately 1,500 degrees Celsius.

Consequently, if the melting temperature of the doped silica layer 140 is reduced to below approximately 1,500 degrees Celsius, then the doped silica layer 140 reaches its melting point before either the cap 130 or the optical fiber 110 reaches their respective melting points. As a result, the cap 130 can be fused to the optical fiber 110 without any detrimental heating effects on the shaped tip 120.

For some embodiments, a doped silica layer 140 is deposited onto an inner surface of capillary tube using a modified chemical vapor deposition (MCVD) process. However, it should be appreciated that other soot-deposition processes (e.g., plasma-activated chemical vapor deposition (PCVD), etc.) may be employed to deposit the doped silica layer 140 and, therefore, the deposition process is not limited to MCVD. Once the doped silica layer 140 is deposited onto the capillary tube, the optical fiber is capped by fusing the doped silica. In other words, the capillary tube, which forms the cap 130, is fused to the optical fiber 110 via the doped silica layer 140. As noted above, doping the doped silica layer 140 with Germanium (Ge), Boron (B), Fluorine (F), or other dopant(s) or co-dopant(s) that reduce the melting temperature, the doped silica layer 140 exhibits a lower melting temperature than either the melting temperature of the cap 130 or the melting temperature of the optical fiber 110.

Although exemplary embodiments have been shown and described, it will be clear to those of ordinary skill in the art that a number of changes, modifications, or alterations to the disclosure as described may be made. For example, while the optical fiber 110 and the cap 130 are described to have a melting temperature that exceeds 1,500 degrees Celsius, it should be appreciated that the specific melting temperature is provided only as an example. Thus, the significance of the disclosure resides in depositing a lower-melting-temperature doped silica layer 140, which has a lower melting temperature than the optical fiber or the cap, irrespective of the actual numerical value of that melting temperature. This, and all other such changes, modifications, and alterations should therefore be seen as within the scope of the disclosure.

What is claimed is:

1. A fiber-optic apparatus, comprising:
a side-firing optical fiber comprising an angled tip, the side-firing optical fiber having a fiber melting temperature that is greater than approximately 1,500 degrees Celsius;
a silica cap covering the angled tip, the cap having a cap melting temperature, the cap melting temperature being greater than approximately 1,500 degrees Celsius; and
a fused glass interface between the side-firing optical fiber and the silica cap, the fused glass interface to secure to silica cap to the side-firing optical fiber, the fused glass interface comprising doped silica, the doped silica having a melting temperature that is lower than approximately 1,500 degrees Celsius.

2. The apparatus of claim 1, the doped silica comprising a dopant, the dopant being one selected from the group consisting of:
Germanium (Ge);
Boron (B);
Fluorine (F); and
a combination thereof.

3. A fiber-optic apparatus, comprising:
an optical fiber comprising a shaped tip; and
a cap covering the shaped tip, the cap being secured to the optical fiber by fusing the cap to the optical fiber using doped silica, the doped silica having a lower melting temperature than the melting temperature of the optical fiber, the doped silica having a lower melting temperature than the melting temperature of the cap.

4. The apparatus of claim 3, the doped silica comprising Germanium (Ge).

5. The apparatus of claim 3, the doped silica comprising Boron (B).

6. The apparatus of claim 3, the doped silica comprising Fluorine (F).

7. The apparatus of claim 3, the doped silica having a melting temperature that is less than approximately 1,500 degrees Celsius.

8. The apparatus of claim 3, the optical fiber having a melting temperature that is greater than approximately 1,500 degrees Celsius.

9. The apparatus of claim 3, the cap having a melting temperature that is greater than approximately 1,500 degrees Celsius.

10. The apparatus of claim 3, the optical fiber being a side-firing optical fiber.

11. The apparatus of claim 3, the shaped tip being an angled tip.

12. The apparatus of claim 3, the cap comprising silica.

13. A method, comprising:
depositing a layer of doped silica on an inner surface of a capillary tube, the doped silica having a lower melting temperature than a melting temperature of the capillary tube; and
capping an optical fiber by fusing the doped silica to the optical fiber.

14. The method of claim 13, depositing the layer of doped silica comprising:
applying a modified chemical vapor deposition (MCVD) process to deposit the layer of doped silica.

15. The method of claim 13, depositing the layer of doped silica comprising:
depositing a layer of Germanium (Ge) doped silica to the inner surface of the capillary tube.

16. The method of claim 13, depositing the layer of doped silica comprising:
depositing a layer of Boron (B) doped silica to the inner surface of the capillary tube.

17. The method of claim 13, depositing the layer of doped silica comprising:
depositing a layer of Fluorine (F) doped silica to the inner surface of the capillary tube.

18. The method of claim 13, depositing the layer of doped silica comprising:
depositing a silica layer having a melting temperature that is lower than a melting temperature of the capillary tube.

19. The method of claim 13, depositing the layer of doped silica comprising:
depositing a silica layer having a melting temperature that is lower than a melting temperature of the optical fiber.
